(19) United States
(12) Patent Application Publication
(10) Pub. No.: US 2024/0039072 A1
(43) Pub. Date: Feb. 1, 2024

(54) BATTERY CELL AND BATTERY PACK INCLUDING THE SAME

(71) Applicant: SK ON CO., LTD., Seoul (KR)

(72) Inventor: Jong Hyuk LEE, Daejeon (KR)

(21) Appl. No.: 18/359,639

(22) Filed: Jul. 26, 2023

(30) Foreign Application Priority Data
Jul. 26, 2022 (KR) 10-2022-0092718

(51) Int. Cl. H01M 10/613; H01M 50/143; H01M 50/533; H01M 50/505; H01M 10/0585; H01M 50/211; A62C 3/16; A62C 3/06

(52) U.S. Cl. CPC H01M 10/613; H01M 50/143; H01M 50/533; H01M 50/505; H01M 10/0585; H01M 50/211; A62C 3/16; A62C 3/06

(57) ABSTRACT

Provided are a battery cell and a battery pack, and more particularly, a battery cell which has a fire extinguishing means for cooling and extinguishing the battery cell when the battery cell is overheated or initially ignited to prevent a battery fire accident, and a battery pack including the same.

### CROSS-REFERENCE TO RELATED APPLICATIONS

This application claims priority under 35 U.S.C. § 119 to Korean Patent Application No. 10-2022-0092718, filed on Jul. 26, 2022, in the Korean Intellectual Property Office, the disclosure of which is incorporated herein by reference in its entirety.

### TECHNICAL FIELD

The following disclosure relates to a battery cell and a battery pack, and more particularly, to a battery cell which has a fire extinguishing means for cooling and extinguishing the battery cell when the battery cell is overheated or initially ignited to prevent a battery fire accident, and a battery pack including the same.

### BACKGROUND

Usually, a secondary battery refers to a rechargeable battery and representatively includes a nickel cadmium battery, a nickel hydrogen battery, a lithium ion battery, and the like. Among them, a lithium ion battery has been spotlighted as a next generation power source due to its excellent characteristics such as a long lifespan and high capacity. A lithium secondary battery, which has an operating voltage of 3.6 V or more, is used as a power supply of a portable electronic device or, when several lithium secondary batteries are connected in series with each other, is used in a high output hybrid vehicle, and since the lithium secondary battery has an operating voltage three times higher and has excellent energy density characteristics per unit weight, as compared with a nickel-cadmium battery or a nickel-metal hydride battery, its use is rapidly increasing.

FIG. 1 illustrates a perspective view of a battery cell 10 which is a basic element configuring a secondary battery. As illustrated, the battery cell 10 includes a battery unit and a case 12 providing a space where the battery unit 11 is accommodated. The battery unit 11 includes a positive electrode plate and a negative electrode plate, and each electrode plate is electrically connected to a positive electrode tab and a negative electrode tab 13 and 14. One end of the positive electrode tab and the negative electrode tab 13 and 14 protrudes outwards through a sealing surface 12a of the case 12. The protruding end of the positive electrode tab and the negative electrode tab 13 and 14 is connected to a terminal of a protection circuit board which is not shown. The case 12 is a pouch type case in which a middle layer is a metal foil and inner and outer skin layers attached to both surfaces of the metal foil are formed of an insulating film. The pouch type case has excellent mold ability and is freely bendable. In the case 12, a space for accommodating the battery unit 11 is formed and a sealing surface 12a which is thermally fused is formed along the edge of the space, as described above.

The battery cell 10 having the configuration as described above produces gas inside when the internal temperature of the case 12 rise due to the factors such as overcharge or a short, and in the case of a secondary battery including a pouch type battery cell, since the stiffness of the case is weak, gas is ejected into a weak portion such as a tab sealing part of the sealing surface, and a thermal runaway phenomenon by a short and the like may occur.

A flame ignited by the thermal runaway phenomenon propagates to an adjacent cell, which leads to a battery fire accident due to a chain ignition phenomenon, and thus, development of a technology for preventing the thermal runaway of the pouch type battery cell is demanded.

### SUMMARY

An embodiment of the present invention is to directed to providing a battery cell which has a fire extinguishing pad in a vulnerable part on a case from which gas may be ejected when gas is generated inside the battery cell to lower the temperature when the temperature of the vulnerable part rises, and extinguishes fire when flames are caused by sparks to prevent fire propagation to an adjacent battery cell, and a battery pack including the same.

Another embodiment of the present invention is to directed to providing a battery cell including a fire extinguishing agent which may vaporize at a certain temperature to cool and extinguish the surroundings and a sealing member which accommodates the fire extinguishing agent and is incised by a vaporization pressure of the fire extinguishing agent to eject the extinguishing agent, and a battery pack including the same.

In one general aspect, a battery cell includes: an electrode assembly including: at least one positive electrode plate, at least one negative electrode plate, and at least one separator; a case accommodating the electrode assembly; and an electrode tab which is connected to the positive electrode plate or the negative electrode plate and has an end protruding out of the case, wherein the battery cell includes a fire extinguishing pad which is provided on an outer surface of the case for cooling or extinguishing the battery cell when the battery cell is overheated or ignited.

In addition, the fire extinguishing pad may include a fire extinguishing agent which vaporizes when the battery cell is overheated or ignited and is sprayed out of the fire extinguishing pad; a carrier which maintains the fire extinguishing pad and supports the fire extinguishing agent accommodated on one side; and a sealing member which is connected to one side of the carrier so as to enclose the fire extinguishing agent and seals the fire extinguishing agent.

In addition, the carrier may include a bottom plate; and a pillar which is formed to extend to one side of the bottom plate and is disposed in a plurality to be spaced apart along a surface direction of the bottom plate, wherein the fire extinguishing agent is accommodated between the pillar and another neighboring pillar.

In addition, the carrier may include a bottom plate which combines with the sealing member to form a fire extinguishing agent accommodation space inside; and a plurality of particles provided in the accommodation space, wherein the particles are disposed to be mixed with the fire extinguishing agent accommodated in the accommodation space.

In addition, the carrier may include at least one selected from the group consisting of incombustible polymer, semi-incombustible polymer, flame retardant polymer, metal, and carbon.

In addition, the carrier may have a porosity of 30% or more so that the fire extinguishing agent is absorbed.

In addition, the fire extinguishing agent may remain a liquid or solid at room temperature and be formed of a material of which the phase changes to a gas phase at 30° C. or higher, and the sealing member may seal the fire extinguishing agent normally, but be broken by vaporization pressure when the fire extinguishing agent vaporizes.

In addition, the fire extinguishing agent may be at least one selected from the group consisting of halogen-based flame retardants, phosphorus-based flame retardants, nitrogen-based flame retardants, inorganic flame retardants, and radical scavengers.

In addition, the fire extinguishing pad may be provided on a sealing surface which is fused along a circumference of the electrode assembly accommodation space on the case.

In addition, the fire extinguishing pad may be provided on a sealing surface side where the electrode tab is sealed.

In addition, the fire extinguishing pad may be provided on an electrode tab sealing part where the electrode tab is sealed on the sealing surface.

In addition, the fire extinguishing pad may be provided on one surface, the other surface, or both surfaces of the battery cell.

In addition, an area of the fire extinguishing pad may correspond to an area of the sealing surface 121, and a thickness of the fire extinguishing pad may be ½ or less of a value obtained by subtracting a thickness of the sealing surface from a thickness of the battery cell.

In addition, the fire extinguishing pad may further include an adhesive member provided on the other surface of the carrier, so that the fire extinguishing pad is attached on an outer surface of the case.

Also, in the fire extinguishing pad, one surface of the carrier may be coated with the fire extinguishing agent and one surface of the carrier coated with the fire extinguishing agent may be coated with the sealing member.

In another general aspect, a battery pack includes: a battery cell including: an electrode assembly including at least one positive electrode plate, at least one negative electrode plate, and at least one separator; a case accommodating the electrode assembly; and an electrode tab which is connected to the positive electrode plate or the negative electrode plate and has an end protruding out of the case; a lower case having a space formed in which a plurality of the battery cells are accommodated in a laminated form; an upper cover which seals an upper open surface of the lower case; and a fire extinguishing pad which is provided on an outer surface of the case for cooling or extinguishing the battery cell when the battery cell is overheated or ignited.

In addition, the battery cell may be accommodated in a plurality in the lower case in a laminated form along the thickness direction of the battery cell.

In addition, the fire extinguishing pad may be provided on one surface, the other surface, or both surfaces of the sealing surface where the electrode tab is sealed on the case, respectively.

In another exemplary embodiment, the fire extinguishing pad may be provided in a space between the battery cell laminated in a plurality and the upper cover.

Also, the battery cell may be fixed by inserting a part of the sealing surface and the electrode tab to an internal busbar for alignment during lamination, and the electrode tab may be connected to a terminal busbar provided on an outer side of the internal busbar.

Other features and aspects will be apparent from the following detailed description, the drawings, and the claims.

### BRIEF DESCRIPTION OF THE DRAWINGS

FIG. 1 is a perspective view of a common battery cell.

FIG. 2 is a perspective view of a battery cell according to an exemplary embodiment of the present invention.

FIG. 3 is a sectional view of the battery cell according to an exemplary embodiment of the present invention.

FIG. 4 is a transverse sectional view of a battery pack according to the first exemplary embodiment of the present invention.

FIG. 5 is a longitudinal sectional view of the battery pack according to the first exemplary embodiment of the present invention.

FIG. 6 is a transverse sectional view of a battery pack according to the second exemplary embodiment of the present invention.

FIG. 7 is a sectional view of a fire extinguishing pad according to the first exemplary embodiment of the present invention.

FIG. 8 is a sectional view of a fire extinguishing pad according to the second exemplary embodiment of the present invention.

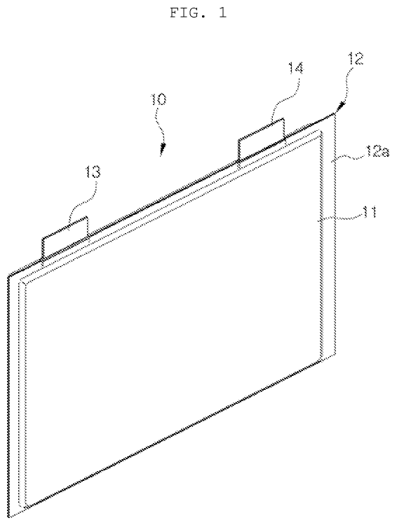

### DETAILED DESCRIPTION OF MAIN ELEMENTS

100: Battery cell
110: Electrode assembly
120: Case
121: Sealing surface
125: Electrode tab sealing part
130: Positive electrode tab
140: Negative electrode tab
200, 300, 500: Fire extinguishing pad
210: Carrier
211: Bottom plate
212: Pillar
215: Particle
220: Fire extinguishing agent
230: Sealing member
250: Adhesive member
1000: Battery cell
1100: Lower case
1200: Upper cover
1500: Terminal busbar
1600: Internal busbar

### DETAILED DESCRIPTION OF EMBODIMENTS

Hereinafter, an exemplary embodiment of the present invention will be described in detail with reference to the accompanying drawings.

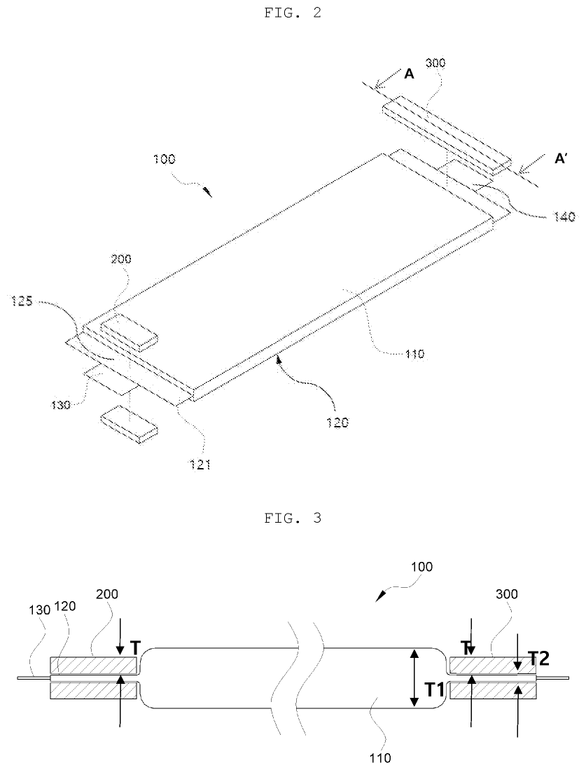

FIG. 2 is a perspective view of a battery cell according to an exemplary embodiment of the present invention. In addition, FIG. 3 is a sectional view of the battery cell according to an exemplary embodiment of the present invention.

Referring to FIG. 2, a battery cell 100 includes an electrode assembly 110 and a case 120 which provides a space accommodating the electrode assembly 110. The electrode assembly 110 has a shape in which a positive electrode plate, a separator, and a negative electrode plate are disposed in this order and wound in one direction or a plurality of positive electrode plates, separators, and negative electrode plates are laminated. The positive electrode plate of the electrode assembly 110 is electrically connected to a positive electrode tab 130, and the negative electrode plate is electrically connected to a negative electrode tab 140. Ends of the electrode tabs 130 and 140 protrude outwards through a sealing surface 121 of the case 120. The protruding ends of the electrode tabs 130 and 140 are connected to a terminal of a protection circuit board which is not shown.

The case 120 is a pouch type case in which a middle layer is a metal foil and inner and outer skin layers attached to both surfaces of the metal foil are formed of an insulating film, unlike a cylindrical or prismatic can structure molded from a thick-film metal material. The pouch type case has excellent mold ability and is freely bendable. In the case 120, a space for accommodating the electrode assembly 110 is formed and the sealing surface 121 which is thermally fused is formed along the edge of the space, as described above.

A plurality of the battery cells 100 having the above configuration are connected in parallel or in series to form a battery pack in order to satisfy high-voltage or high-current secondary battery specifications, and a battery module is obtained by laminating and modulating two battery cells for facilitating battery pack assembly.

Herein, the positive electrode tab 130 and the negative electrode tab 140 in the battery cell 100 are the parts to which an electrode is connected and of which the temperature is relatively high since resistance heat occurs by current concentration. Therefore, as the temperature of the electrode tabs 130 and 140 rises, when the case 120 expands due to gassing inside the battery cell 100, a vent occurs in a sealing part 125 which is relatively vulnerable on a sealing surface 121 of the case 120, thereby ejecting combustible gas. In addition, the temperature rise itself of the electrode tab sealing part 125 may impair a sealing force of the sealing surface 121. Therefore, in order to lower temperature in the case of a temperature rise of the electrode tab sealing part 125 or extinguish fire in the case of fire due to sparks, the present invention has the following configuration.

A battery cell 100 is configured to include fire extinguishing pads 200 and 300. The fire extinguishing pads 200 and 300 are configured so that when the temperature of the battery cell 100 rises, the fire extinguishing agent inside is sprayed to lower the surrounding temperature and, when flames are caused by sparks, the flames are extinguished to prevent fire propagation to an adjacent battery cell. The fire extinguishing agent is configured so that it is liquid at room temperature but vaporizes at a certain temperature or higher to lower the surrounding temperature by the vaporization heat and extinguish fire.

To this end, the fire extinguishing pads 200 and 300 may be formed to be attached on the sealing surface 121 to eject gas inside the battery cell 100. More specifically, the fire extinguishing pads 200 and 300 may be attached to the sealing surface on the side of the sealing surface 121 where the electrode tab 130, 140 is sealed. In addition, the fire extinguishing pads 200 and 300 may be configured to include a first pad 200 attached on an electrode tab sealing part 125 which is a part where the electrode tab 130 is sealed, that is, a heat concentration part, and a second pad 300 attached on the entire sealing surface 121 including the circumference on the side where the electrode tab 140 is sealed.

In addition, as illustrated in FIG. 3, a pair of the first pads 200 may be attached to one surface and the other surface of the sealing surface 121, respectively, and the second pad 300 may be attached to only anyone surface of the one surface and the other surface of the sealing surface 121.

Meanwhile, it is preferred that the areas of the fire extinguishing pads 200 and 300 correspond to the area of the sealing surface 121, considering the electrode tab connection. In addition, it is preferred that the thickness (T) of the fire extinguishing pads 200 and 300 is ½ or less of the value obtained by subtracting the thickness (T2) of the sealing surface from the thickness (T1) of the battery cell. That is, the thickness may be configured not to protrude outwards in the thickness direction of the battery cell when the fire extinguishing pads 200 and 300 are attached so that no interfere occurs when the battery cell is laminated.

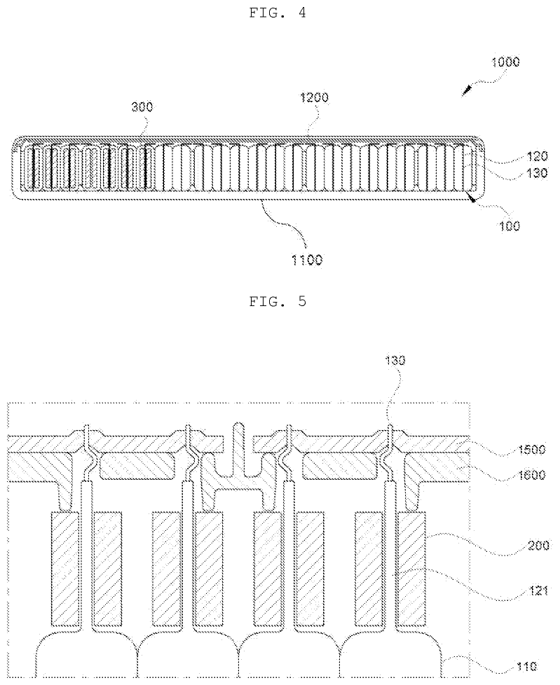

FIG. 4 is a transverse sectional view of the battery pack 1000 according to the first exemplary embodiment of the present invention, and FIG. 5 is a longitudinal sectional view of the battery pack 1000 according to the first exemplary embodiment.

As illustrated, the battery pack 1000 may be configured to include a lower case 1100 having a space for accommodating a plurality of battery cells 100 formed inside and an upper cover 1200 which seals the upper open surface of the lower case 110.

The battery cell 100 may be accommodated in a plurality in the lower case 1100 in the form of being laminated along the thickness direction of the battery cell 100. In addition, the battery cell 100 may be fixed by a part of the sealing surface 121 and the electrode tab 130 being inserted into an internal busbar 1600 formed of a resin material for alignment in lamination, and the electrode tab 130 may be electrically connected to the terminal busbar 1500 provided on the outside of the internal busbar 1600. Herein, the fire extinguishing pad 300 may be attached on one surface and the other surface of the sealing surface 120 to which the electrode tab 130 is sealed, respectively.

In particular, the size of the fire extinguishing pad 200 corresponds to the area of the sealing surface 121, and the thickness is configured not to protrude outwards in the thickness direction of the battery cell when attached so that no interference occurs in the lamination of the battery cell 100, whereby the lamination thickness of the battery cell 100 is not affected. Therefore, the fire extinguishing pad 200 of the present invention may be applied to the conventional battery cell 100 or battery pack 1000, and it is not required to change the design of the conventional battery cell 100 or battery pack 1000.

FIG. 6 is a transverse sectional view of the battery pack 1000 according to the second exemplary embodiment of the present invention.

As illustrated, the battery pack 1000 may be configured to include a lower case 1100 having a space for accommodating a plurality of battery cells 100 formed inside and an upper cover 1200 which seals the upper open surface of the lower case 110.

The battery cell 100 may be accommodated in a plurality in the lower case 1100 in the form of being laminated along the thickness direction of the battery cell 100. Herein, the fire extinguishing pad 500 according to the second exemplary embodiment of the present invention may be provided in a space between a battery cell 100 laminated in a plurality and an upper cover 1200. Herein, the thickness of the fire extinguishing pad 500 may correspond to a space between the upper of the battery cell 100 and the upper cover 1200. However, it is preferred that a maximum thickness is a thickness not to cause deformation of a pouch by pressure transferred to the battery cell 100 due to the fire extinguishing pad 500, when the upper cover 1200 is combined, and a minimum thickness is a thickness to accommodate the fire extinguishing agent in an amount which may be expected to have sufficient cooling or extinguishing performance. The fire extinguishing pad 500 may be provided to be singular or divided into plural parts.

Hereinafter, the detailed configuration of the fire extinguishing pad 200 which performs the above role will be described in detail referring to the drawings.

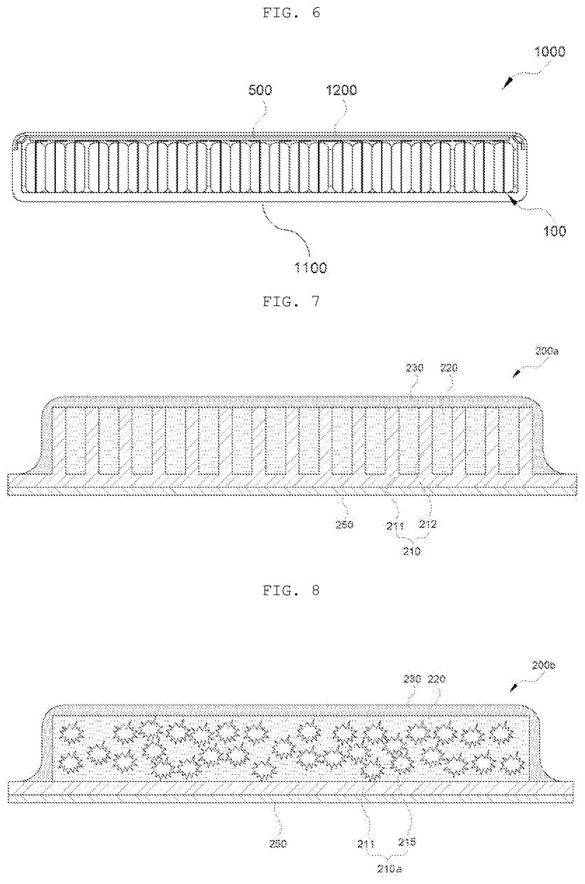

FIG. 7 is a sectional view (AA′ of FIG. 2) of the fire extinguishing pad 200a according to the first exemplary embodiment of the present invention.

### First Exemplary Embodiment (Pillar Type)

As illustrated, the fire extinguishing pad 200a includes a first carrier 210 for maintaining a fire extinguishing pad shape and supporting the fire extinguishing agent accommodated inside, a fire extinguishing agent 220 which remains in a liquid or solid state at room temperature, and, when the battery cell is overheated, vaporizes and is sprayed out of the fire extinguishing pad to cool and extinguish the battery cell; a sealing member 230 which is combined along the circumference of the first carrier 210 and encloses and seals the fire extinguishing agent 220 in order to block the fire extinguishing agent 220 from the outside in usual time, and, when the fire extinguishing agent 220 vaporizes, is broken by pressure to spray the fire extinguishing agent 220 externally; and an adhesive member 250 for attaching the fire extinguishing pad to the battery cell.

The first carrier 210 is formed of a bottom plate 211 and a pillar 212 formed to extend to one side of the bottom plate 211. The pillar 212 is disposed in a plurality to be spaced apart along a surface direction of the bottom plate 211 so that the fire extinguishing agent 220 is accommodated between the pillar 212 and another neighboring pillar 212, and, when the first carrier 210 is coated with the fire extinguishing agent 220, is configured to expand the coating area. The first carrier 210 may be formed of an organic and inorganic, incombustible, semi-incombustible, or flame retardant material. As an example, it may be formed of polyurethane, polyisocyanurate, soft PUR, hard semi-incombustible PIR, phenol form, metal form, carbon form, and the like having an open cell structure. As another example, the first carrier 210 may include an inorganic flame retardant, a phosphorus-based flame retardant, a halogen-based flame retardant, and the like. Therefore, a secondary fire extinguishing function such as a neutralizing effect of the flame retardant and oxygen blocking by char formation may be performed by the first carrier 210. In addition, the first carrier 210 may be configured to have a porosity above a certain level so that the fire extinguishing agent 220 is partly absorbed. More specifically, the porosity may be 30% or more, and as an example, may be a foam. Therefore, the first carrier 210 is configured to accommodate the fire extinguishing agent as much as possible while the structure of the fire extinguishing pad is maintained.

As the fire extinguishing agent 220, dibromomethane or the like which remains liquid or solid at room temperature and of which the phase changes to a gas phase at a temperature between 30° C. and 100° C. may be used. The fire extinguishing agent temporarily lowers the surrounding temperature when ejected outwards, thereby lowering the surrounding temperature below smoke point, so that fire is prevented when flammable gas is ejected and, in the case of fire, fire is extinguished through extinguishing gas. In addition, the fire extinguishing agent 220 may include a flame retardant or a radical scavenger. Thus, a combustion retardation effect may be promoted. For the fire extinguishing agent 220, the flame retardant and the liquid fire extinguishing agent may be mixed and coated on the first carrier 210 to manufacture the first carrier 210 including the fire extinguishing agent 220.

The fire extinguishing agent is formed of, as an example, a halogen-based agent which remains liquid at room temperature, such as perfluoro(2-methyl-3-pentanone) and dibromomethane, and for further strengthening the flame retardancy, those consisting of decabromodiphenyl oxide (DBDPO), hexabromocyclododecane (HBCD), tetrabromobisphenol-A (TBBA), tetrabromobisphenol-A bis (2,3-dibromopropyl ether) (BDDP), and the like as a halogen-based flame retardant, those consisting of red phosphorus, phosphoric acid ester-based, phosphate, phosphonate, phosphinate, phosphine oxide, phosphazene, and the like, as a phosphorus-based flame retardant, those consisting of melamine, melamine cyanurate, triphenylisocyanurate, melamine phosphate, melamine pyrophosphate, ammonium polyphosphate, alkyl amine phosphate, and the like, as a nitrogen-based flame retardant, those consisting of antimony trioxide, antimony tetraoxide, antimony pentaoxide, sodium antimonate carbonate, metal antimony, antimony trichloride, antimony pentachlroride, barium metaborate, zirconium oxide, zinc borate, zinc tartarate, magnesium hydroxide, aluminum hydroxide, and the like, as a metal-based inorganic oxide an inorganic flame retardant, or an organic compound such as ascorbic acid or tannic acid as a radical scavenger may be further combined.

The sealing member 230 is formed of a polymer material having a predetermined thickness and is configured to enclose the pillar 212 and the fire extinguishing agent 220. In addition, the circumference may be combined to the circumference of the bottom plate 211 so that sealing is performed in a state of accommodating the pillar 212 and the fire extinguishing agent 220 inside. ✓As an example, the sealing member 230 may be formed by coating one surface of the first carrier 210 including the fire extinguishing agent 220 with a polymer material. The sealing member 230 may be made of any material as long as the material may be broken by the vaporization pressure of the fire extinguishing agent, and as an example, may be formed of gelatin, gum arabic, sodium alginate, carboxymethyl cellulose, carrageenan, polyvinyl alcohol, polyethylene, polyvinyl chloride, and the like.

The adhesive member 250 is formed of an adhesive material, and is provided on the other side of the bottom plate 211 and configured to attach the fire extinguishing pad 220 to the battery cell 100.

FIG. 8 is a sectional view of a fire extinguishing pad 200b according to the second exemplary embodiment of the present invention.

### Second Exemplary Embodiment (Particle Type)

As illustrated, the fire extinguishing pad 200b includes a second carrier 210a, a fire extinguishing agent 220, a sealing member 230, and an adhesive member 250.

Herein, the second carrier 210a is configured to include a bottom plate 211 and a plurality of particles 215 provided in the accommodation space inside the sealing member 230 when combining the bottom plate 211 and the sealing member 230. The particle 215 has a predetermined volume and is configured to evenly distributed on the fire extinguishing agent 220 which is accommodated in the internal accommodation space. The particle 215 may be formed of an inorganic substance or an incombustible, semi-incombustible, or flammable retardant polymer. In addition, a binder may be applied to the particle 215. It may be a polymer foam including a polymer having an open cell structure and an inorganic substance without a binder. Therefore, when the sealing member 230 is broken, the fire extinguishing agent 220 is primarily ejected to temporarily lower the surrounding temperature, thereby lowering the surrounding temperature below smoke point, so that fire is prevented when flammable gas is ejected and, in the case of fire, fire is extinguished through extinguishing gas. In addition, when flames are maintained without fire extinguishing, a combustion retardation effect may be secondarily promoted by particles 215 ejected with the fire extinguishing agent 220.

Hereinafter, other constituent elements of the fire extinguishing pad 220b of the second exemplary embodiment may be configured identically to the fire extinguishing pad 200a of the first exemplary embodiment described above.

Since the battery cell and the battery pack including the same of the present invention according to the configuration described above have a fire extinguishing pad including a temperature-sensitive fire extinguishing agent which is disposed in a part vulnerable to gas ejection, they have an effect of preventing battery pack fire by cooling and extinguishing the battery cell by ejecting a fire extinguishing agent when the vulnerable part is heated to prevent thermal runaway.

The fire extinguishing pad is in the form of being attached to the sealing part of the battery cell, and since it is disposed in a surplus space inside the battery pack, it may be applied without changing the design of the conventional battery cell or battery pack.

Since to the inside of the fire extinguishing pad, a fire extinguishing agent, a flame retardant, or the like may be selectively applied, a battery cell specialized for various purposes such as overheat protection, fire prevention, or fire suppression and a battery pack including the same may be manufactured.

The present invention should not be construed to being limited to the above-mentioned exemplary embodiment. The present invention may be applied to various fields and may be variously modified by those skilled in the art without departing from the scope of the present invention claimed in the claims. Therefore, it is apparent to those skilled in the art that these alterations and modifications fall in the scope of the present invention.

What is claimed is:

1. A battery cell comprising: an electrode assembly including: at least one positive electrode plate, at least one negative electrode plate, and at least one separator; a case accommodating the electrode assembly; and an electrode tab which is connected to the positive electrode plate or the negative electrode plate and has an end protruding out of the case,
wherein the battery cell includes a fire extinguishing pad which is provided on an outer surface of the case for cooling or extinguishing the battery cell when the battery cell is overheated or ignited.

2. The battery cell of claim 1, wherein the fire extinguishing pad includes:
a fire extinguishing agent which vaporizes when the battery cell is overheated or ignited and is sprayed out of the fire extinguishing pad;
a carrier which maintains the fire extinguishing pad and supports the fire extinguishing agent accommodated on one side; and
a sealing member which is connected to one side of the carrier so as to enclose the fire extinguishing agent and seals the fire extinguishing agent.

3. The battery cell of claim 2, wherein the carrier includes:
a bottom plate; and
a pillar which is formed to extend to one side of the bottom plate and is disposed in a plurality to be spaced apart along a surface direction of the bottom plate,
wherein the fire extinguishing agent is accommodated between the pillar and another neighboring pillar.

4. The battery cell of claim 2, wherein the carrier includes:
a bottom plate which combines with the sealing member to form a fire extinguishing agent accommodation space inside; and
a plurality of particles provided in the accommodation space,
wherein the particles are disposed to be mixed with the fire extinguishing agent accommodated in the accommodation space.

5. The battery cell of claim 2, wherein the carrier includes: at least one selected from the group consisting of incombustible polymer, semi-incombustible polymer, flame retardant polymer, metal, and carbon.

6. The battery cell of claim 2, wherein the carrier has a porosity of 30% or more so that the fire extinguishing agent is absorbed.

7. The battery cell of claim 2,
Wherein the fire extinguishing agent remains a liquid or solid at room temperature and is formed of a material of which the phase changes to a gas phase at 30° C. or higher, and
the sealing member seals the fire extinguishing agent normally, but is broken by vaporization pressure when the fire extinguishing agent vaporizes.

8. The battery cell of claim 2, wherein the fire extinguishing agent is at least one selected from the group consisting of halogen-based flame retardants, phosphorus-based flame retardants, nitrogen-based flame retardants, inorganic flame retardants, and radical scavengers.

9. The battery cell of claim 1, wherein the fire extinguishing pad is provided on a sealing surface which is fused along a circumference of the electrode assembly accommodation space on the case.

10. The battery cell of claim 9, wherein the fire extinguishing pad is provided on a sealing surface side where the electrode tab is sealed.

11. The battery cell of claim 10, wherein the fire extinguishing pad is provided on an electrode tab sealing part where the electrode tab is sealed on the sealing surface.

12. The battery cell of claim 1, wherein the fire extinguishing pad is provided on one surface, the other surface, or both surface of the battery cell, respectively.

13. The battery cell of claim 9, wherein an area of the fire extinguishing pad corresponds to an area of the sealing surface, and
a thickness of the fire extinguishing pad is ½ or less of a value obtained by subtracting a thickness of the sealing surface from a thickness of the battery cell.

14. The battery cell of claim 2, wherein the fire extinguishing pad further includes: an adhesive member provided on the other surface of the carrier so that the fire extinguishing pad is attached on the outer surface of the case.

15. The battery cell of claim 2, wherein in the fire extinguishing pad,
one surface of the carrier is coated with the fire extinguishing agent, and
one surface of the carrier coated with the fire extinguishing agent is coated with the sealing member.

16. A battery pack comprising:
a plurality of battery cells including: an electrode assembly including: at least one positive electrode plate, at least one negative electrode plate, and at least one separator; a case accommodating the electrode assembly; and an electrode tab which is connected to the positive electrode plate or the negative electrode plate and has an end protruding out of the case;
a lower case having a space formed in which a plurality of the battery cells are accommodated in a laminated form;
an upper cover which seals an upper open surface of the lower case; and
a fire extinguishing pad which is provided on an outer surface of the case for cooling or extinguishing the battery cell when the battery cell is overheated or ignited.

17. The battery pack of claim 16, wherein the battery cell is accommodated in a plurality in the lower case in the form of being laminated in the thickness direction of the battery cell.

18. The battery pack of claim 17, wherein the fire extinguishing pad is provided on one surface, the other surface, or both surfaces of a sealing surface where the electrode tab is sealed on the case, respectively.

19. The battery pack of claim 17, wherein the fire extinguishing pad is provided in a space between the battery cell laminated in a plurality and the upper cover.

20. The battery pack of claim 17, wherein the battery cell is fixed by inserting a part of the sealing surface and the electrode tab to an internal busbar for alignment during lamination, and the electrode tab is connected to a terminal busbar provided on an outer side of the internal busbar pack.
